(19) United States
(12) Patent Application Publication
(10) Pub. No.: US 2008/0270805 A1
(43) Pub. Date: Oct. 30, 2008

(54) Method for Protecting Intellectual Property Cores on Field Programmable Gate Array

(76) Inventor: Thomas A. Kean, (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/166,716

(22) Filed: Jul. 2, 2008

Related U.S. Application Data
(63) Continuation of application No. 10/172,802, filed on Jun. 13, 2002.

(30) Foreign Application Priority Data
Jun. 13, 2001 (GB) GB0114317.1

(51) Int. Cl. G06F 21/02

(52) U.S. Cl. 713/189

(57) ABSTRACT

Techniques are used to protect intellectual property cores on field programmable gate arrays. An approach is to associate each field programmable gate array, or a limited number of field programmable gate arrays, with a secret key. Each field programmable gate array may only be properly configured or programmed by an appropriate encrypted bitstream (which includes one or more intellectual property cores). This encrypted bitstream has been encoded by or for the secret key associated with a particular FPGA. Other techniques are also presented in this application and include network-based, nonnetwork-based, software-based, layered, and other approaches. The techniques allow an intellectual property core vendor to charge a customer per-use or per-configuration of their intellectual property. This is because an encrypted bitstream is useable only in a limited number, possibly just one, of the integrated circuits.

### CROSS-REFERENCES TO RELATED APPLICATIONS

This application is a continuation of application Ser. No. 10/172,802 filed on Jun. 13, 2002, which claims priority to United Kingdom patent application GB 0114317.1, filed Jun. 13, 2001, all of which are expressly incorporated by reference along with all references cited in this application.

### BACKGROUND OF THE INVENTION

This invention relates to programmable integrated circuits such as field programmable gate arrays (FPGAs) the invention provides cryptographic personalization for such devices so that programming information must be customized individually for each device and proposes novel business models based on this personalization.

FPGA user designs are converted by computer aided design (CAD) implementation software into so called “bitstream” files which can be loaded onto the chips and program the electrical switches to create the desired circuit. In the prior art approach each FPGA of the same type will accept the same bitstream file so that a user can configure an unlimited number of FPGAs with the bitstream information from their design. This configuration paradigm is obvious, simple and easy to implement, and has many advantages. From the point of view of the FPGA vendor it is a “pay per use” model since even though a bitstream will run on an unlimited number of FPGAs the FPGAs themselves must be purchased individually. Today, in the FPGA market chips which will load a particular bitstream are, in general, only available from a single supplier. This model for distributing FPGA bitstreams is similar to the standard paradigm for software distribution to personal computers where a program file can be installed and run on any computer with the correct processor, operating system, and resources.

Recently, improvements in process technology and device architecture have allowed very large circuits to be implemented on FPGAs. FPGAs can now implement designs with the equivalent of several million gates of logic and medium sized memory blocks. FPGAs with on board microcontrollers, implemented either directly in silicon or on the FPGA resources are also becoming available. In fact, FPGAs or configurable system on chip (CSoC) parts from companies such as Xilinx, Altera, and Triscend are becoming “platforms” for implementing entire systems rather than just “glue” logic blocks. Technical information on these products is available from the internet sites of the manufacturers (www.xilinx.com, www.altera.com, and www.triscend.com).

This trend to implement entire systems on an FPGA is creating a market for intellectual property “cores.” These are designs created by third parties and are sold to FPGA users to incorporate in their own designs. Examples of cores include, bus interfaces such as the PCI bus, signal processing functions such as Viterbi and Reed Solomon decoders and communications interface functions such as serializer/deserializer (SERDES). Leading FPGA manufacturers now offer access to a large catalogue of these “cores” and customers expect to be able to create a large part of the functionality of their system using “cores”-thus reducing their time to market and engineering effort.

An important difficulty for the FPGA core industry is that there is no way for a core vendor to monitor how many times their core has been configured into an FPGA by a particular customer. For this reason it is common for third-party core vendors to have a one time “license” charge to access the design files rather than a “per use” charge. This is an undesirable business model since it means that a customer with a small-volume application must pay the same license fee as a customer who will sell millions of units. Further, customers have to pay the entire license fee “up front” long before obtaining revenue from product sales. Customers might be willing to pay much more for intellectual property if the charges were a fraction of their own sales rather than a fixed up-front charge.

In order to make a return on the engineering time invested the core vendors are forced to charge high fees to access the core—which has the effect of pricing the core beyond the reach of users with low volume applications. Unfortunately, FPGAs have the greatest market advantage over mask-programmed application specific integrated circuits (ASICs) in low volume applications. This poor match between market requirements and the license fee business model has deterred companies from entering the FPGA IP core market and, at present, a high percentage of the available cores are in fact supplied by the FPGA vendors—either free of charge or for nominal fees—in order to stimulate chip sales. As FPGA chip sizes continue to increase it will become impossible for FPGA vendors to provide all the necessary cores. It is in everyone's interest: FPGA customers, FPGA vendors, and third party IP suppliers to find a business model by which core vendors can receive “per-use” payments for their intellectual property in order to create a viable market for IP cores.

Recently, a new class of companies has emerged offering “silicon intellectual property” or silicon IP. Silicon IP are “cores” which are implemented in silicon within application specific integrated circuits unlike the cores discussed above which are implemented within user designs for FPGAs. Some vendors, such as Adaptive Silicon, are offering silicon IP cores which implement FPGA functions. Such cores are used to increase the range of application of a large system on chip (SoC) ASIC and to allow flexibility through in-the-field reconfiguration. Like traditional FPGA companies this class of silicon IP provider must also address the need for IP cores for use in user designs targeted at its architecture. However, unlike FPGA manufacturers Silicon IP companies do not manufacture the chips that contain their design themselves and generally receive the majority of their revenue from licensing fees rather than royalties on each chip containing their silicon cores. Silicon IP vendors face the same kind of pressure on revenue as FPGA core.

When a customer compares the price of an FPGA against that of an ASIC implementing the same function in general the FPGA will cost significantly more per unit and offer less performance. The reason for this is that the programmable switches in an FPGA and their associated control memory require considerable silicon area and the programmable switches add resistance and capacitance compared with metal interconnect in an ASIC. This additional cost is particularly obvious in the case of silicon IP, since a silicon IP customer is building an ASIC and has the choice of implementing the function in hardwired ASIC gates. Most customers for FPGA chips cannot access ASIC technology whatever its unit cost and performance advantages because their applications do not have high enough volume to justify the high non-recurring engineering (NRE) tooling charges involved.

The benefit of the FPGA comes when it is reconfigured in the field to upgrade products or correct design errors. Benefit also arises when the FPGA core on a system chip is used to customize the chip and increase its range of application by loading different designs into different chips. If a method was available by which an FPGA or FPGA silicon IP vendor could make a per-unit charge to customers for configuring the design in the field or for loading different designs into the FPGA silicon IP core on a particular system chip as well as conventional license fees for the core itself they could build a much more attractive business while reducing the perceived cost advantage of implementing logic directly in ASIC.

The need to obtain revenue and control reconfiguration after the initial manufacture of a product containing an FPGA or SoC chip with an FPGA core is reinforced by the trend in high-volume consumer applications to supply equipment at or below cost in order to lock the consumer in to subsequent service sales (for example in the case of a cellular telephone) or software sales (for example in the case of a games console). In this model there is intense price pressure on the initial component costs-since the initial equipment sale does not generate revenue. However, subsequent software and service sales are highly profitable and FPGA manufacturers and silicon IP core vendors may have less trouble obtaining fees for facilitating and controlling access to this market.

### SUMMARY OF THE INVENTION

This invention provides techniques to protect intellectual property cores on field programmable gate arrays. An approach is to associate each field programmable gate array, or a limited number of field programmable gate arrays, with a secret key. Each field programmable gate array may only be properly configured or programmed by an appropriate encrypted bitstream (which includes one or more intellectual property cores). This encrypted bitstream has been encoded by or for the secret key associated with a particular FPGA. Other techniques are also presented in this application and include network-based, nonnetwork-based, software-based, layered, and other approaches. The techniques allow an intellectual property core vendor to charge a customer per-use or per-configuration of their intellectual property. This is because an encrypted bitstream is useable only in a limited number, possibly just one, of the integrated circuits.

In an embodiment, the invention is a method including manufacturing field programmable gate array integrated circuits, each integrated circuit having an identification code and a secret cryptographic key. The method further includes creating a database of identification codes and secret cryptographic keys, where a field programmable gate array integrated circuit with a particular identification code is configurable using a bitstream encrypted using a secret cryptographic key associated with the particular identification code.

Each field programmable gate array integrated circuit may have a unique identification code. The database may be stored on a computer-readable medium. For example, the medium may be a magnetic or optical disk. The identification code and secret cryptographic key may be imprinted on each field programmable gate array using a laser. The identification code may have at least 64 bits. The secret cryptographic key may have at least 128 bits. [0015] In an embodiment, the invention is a method including receiving an identification code of a programmable integrated circuit, obtaining an encryption key associated with the identification code, and encrypting a bitstream file using the encryption key into an encrypted bitstream. The encrypted bitstream is provided, where the encrypted bitstream may be used to configure the programmable integrated circuit with a design as specified in the bitstream file.

Furthermore, a transaction fee may be deducted from an account of a customer purchasing the encrypted bitstream. An account of a provider of the bitstream file may be credited. The identification code of the programmable integrated circuit may be determined by accessing a JTAG interface of the programmable integrated circuit. The programmable integrated circuit may be an FPGA. Obtaining an encryption key may include looking up in a database an encryption key associated with the identification code. Obtaining an encryption key may include generating the encryption key using the identification code. Obtaining an encryption key may include loading an encrypted header file into the programmable integrated circuit. The bitstream file may include IP cores of two or more IP core vendors and the method further includes crediting accounts of the two or more IP core vendors.

In another embodiment, the invention is a method including receiving a request over a network from a customer to purchase an IP core for a field programmable gate array integrated circuit. The customer is charged a price for the IP core. An identification code is obtained for the field programmable gate array integrated circuit. An encrypted bitstream including the IP core is sent over the network, where the encrypted bitstream may be used to configure the field programmable gate array integrated circuit with the identification code.

The network may include the Internet, wireless data transfer, optical data transfer, telephone line data transfer, or modem data transfer. The identification code may be obtained through a JTAG interface of the field programmable gate array integrated circuit. The identification code may be unique to the field programmable gate array integrated circuit.

In an embodiment, the invention is a method including receiving a request over a network from a customer to purchase a design file for configuring a field programmable gate array integrated circuit, where the design file comprises one or more IP cores. The customer is charged a price for the design file. An identification code is obtained for the field programmable gate array integrated circuit. An encrypted bitstream for the design file is sent over the network, where the encrypted bitstream may be used to configure the field programmable gate array integrated circuit with the identification code.

In an embodiment, the invention is a method including receiving a first encrypted bitstream file, which may not be directly used to configure a field programmable gate array, and decrypting and reencrypting the first encrypted bitstream into a second encrypted bitstream file, which may be used to directly configure the field programmable gate array.

In an embodiment, the invention is a method including: loading and decrypting a first encrypted header in a field programmable gate array using a first key; determining a second key stored in the first encrypted header; loading and decrypting a second encrypted header into the field programmable gate array using the second key; determining a first user identification code stored in the second encrypted header; comparing the first user identification code stored in the second encrypted header against a second user identification code stored on the field programmable gate array; if the first and second user identification codes match, loading and decrypting a third encrypted header using the second key; and configuring the field programmable gate array with bitstream information stored in the third encrypted header if a first checksum stored in the third encrypted header matches a second checksum stored in the second encrypted header.

It is an aspect of this invention to radically alter the present business models of the FPGA industry by providing a cryptographically supported method for configuring FPGAs in which the FPGA manufacturer or another trusted agency maintains control of the bitstream supplied to each individual FPGA chip and it is not possible to use a bitstream generated for one chip to configure an unlimited number of other chips.

A further aspect of this invention is to provide a method for intellectual property core vendors to obtain per-use licensing revenues for cores configured into FPGA chips.

A further aspect of the invention is to allow intellectual property cores to contain other intellectual property cores and allow the individual core owners to obtain license revenue whenever their core is used.

A further aspect of the invention is to provide a means by which FPGA manufacturers can obtain additional revenue every time the configuration of an FPGA chip is altered, for example by field upgrades.

A further aspect of the invention is to allow design houses to provide and sell complete FPGA bitstreams which implement a desired function and to obtain per-use license revenue for these “virtual application specific standard products” (VASSPs).

A further aspect of the invention is to allow FPGA vendors or trusted external parties to obtain revenue by administrating a market in IP cores and collecting accounting data on the usage of various cores by customers.

A further aspect of the invention is to protect confidential design information and prevent reverse engineering and removal of copyright protection mechanisms from design source files.

A further aspect of the invention is to allow FPGA manufacturers, companies who provide FPGA cores for use in ASICs and users of FPGAs or FPGA cores to prevent unauthorized third parties from creating bitstreams to reconfigure FPGAs in equipment in the field.

A further aspect of the invention is to provide cryptographic support for a pricing model under which FPGA vendors reduce the up front cost of their chips or license fees for their silicon-IP cores in order to better compete with mask-programmed ASIC technology on cost and compensate for this revenue by making charges for each time devices are configured.

A further aspect of this invention is to provide this security with a minimum of inconvenience to the parties involved in the transaction.

Advantages of this method of securing intellectual property include:

Core vendors do not have to disclose their design to competitors or end-users.

It is straightforward to support designs which use multiple cores from several vendors.

FPGA manufacturers can be sure that any cores they supply free of charge can only be used with their own chips.

FPGA manufacturers are provided with an additional revenue stream.

Customers only pay for intellectual property when they actually manufacture products, thus there is no business risk in paying large up front license fees for intellectual property before it is known what the market demand for the product will be.

Cores can be evaluated risk free.

Small companies with limited budgets and low volume applications can make use of intellectual property cores.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 shows a conventional business relationships among parties involved in designing and using FPGAs.

FIG. 2 shows a set of business relationships among parties involved in designing and using FPGAs according to this invention.

FIG. 3 shows input and output information for prior-art core-generator software.

FIG. 4 shows the relationship between the FPGA designer's computer and the Trusted External Party's server in a network based embodiment of this invention.

FIG. 5 shows the relationship between the FPGA vendor's computer and the Trusted External Party's server in a network based embodiment of this invention.

FIG. 6 shows the relationship between the Trusted External Party's server and the FPGA customer's computer in a network based embodiment of this invention.

FIG. 7 shows various databases maintained on the Trusted External Party's server.

FIG. 8 shows the design implementation software in an embodiment of the invention based on trusted software.

FIG. 9 shows the configuration software in an embodiment of the invention based on trusted software.

FIG. 10 shows FPGA header information according to an embodiment of the invention.

FIG. 11 shows FPGA bitstream information according to an embodiment of the invention.

FIG. 12 shows FPGA bitstream header information according to an embodiment of the invention.

FIG. 13 shows download of bitstream information to an FPGA in the field according to an embodiment of the invention.

FIG. 14 shows layered encryption used to secure download of bitstream information to an FPGA in the field according to an embodiment of the invention.

### DETAILED DESCRIPTION OF THE INVENTION

Aspects of the invention disclosed in this application are related to the applicant's copending applications GB 9930145.9 and U.S. patent application Nos. 60/181,118 and 09/747,759, “Method and Apparatus for Secure Configuration of a Field Programmable Gate Array,” and GB 0002829.0 and U.S. patent application Ser. No. 09/780,681, “Method of Using a Mask Programmed Key to Securely Configure a Field Programmable Gate Array,” which are incorporated by reference.

The invention makes use of cryptographic techniques disclosed in the applicants copending patent applications and in standard textbooks on cryptography including “Applied Cryptography, 2nd Edition” by Bruce Schneier ISBN 0-471-12845-7, published by John Wylie and Sons, 1996 which is incorporated by reference. Aspects of the cryptographic protocols covered by these documents are described only briefly here. In this application reference is made to “encryption,” “public key encryption,” “cipher block chaining” and cryptographic hash functions, these topics are covered in detail in the Schneier textbook and the applicant's earlier patent applications cited above. Many algorithms are presented in the literature which can implement these functions effectively and the techniques described here are not limited to a particular algorithm choice. For example, encryption may be implemented using the triple-DES algorithm or Rijndael algorithm (see “The Rijndael Algorithm: AES Proposal,” First AES Candidate Conference (AES 1), Aug. 20-22, 1998), public key encryption may be implemented using the RSA algorithm and cryptographic hash may be implemented using the MD5 algorithm.

Parties to the IP Transaction

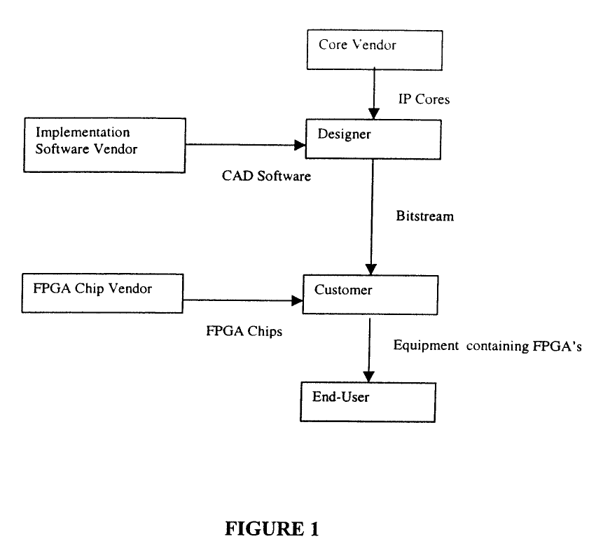

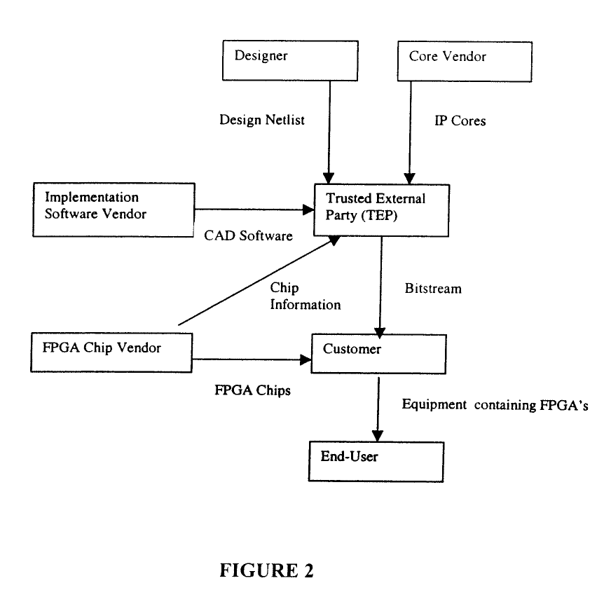

Before discussing IP security schemes in detail it is worth defining the various parties involved in more detail. FIG. 1 shows an abstract and simplified model of the relationships between the various parties in a conventional business model which is helpful in understanding the security requirements. FIG. 2 shows an abstract and simplified model of the relationships between the parties according to the present invention.

The “End User”—purchases equipment containing FPGAs. The end user may become a participant in the licensing process if the equipment allows downloading new designs into the FPGA after the equipment is delivered to the user. Other parties in the process may wish to limit the end users ability to “clone” equipment by copying the FPGA bitstream file or to replace the FPGA design with one which changes the equipment's functionality. For example, in the case of a cellular telephone containing an FPGA the user might wish to reconfigure the FPGA to avoid service charges.

The “FPGA Customer”—designs and manufactures equipment which uses FPGAs. To do this the customer requires bitstream files for “user designs” which when loaded onto the FPGA cause it to perform the desired functions in the equipment. These “user designs” may include intellectual property blocks or “cores” which implement a portion of the required function.

The “Designer”—creates a complete design for an FPGA chip. The design may make use of one or more “IP cores” purchased from Core vendors or obtained from the FPGA vendor. The design can be converted into a bitstream file for the FPGA chip using the FPGA vendor's implementation software. Normally the “Designer” and “Customer” are the same organization but there is no reason why this should always be the case and so for the purpose of describing the protocols it is helpful to separate the two roles.

The “Core Vendor”—designs intellectual property cores for resale. These cores may be provided as hardware description language (HDL) files, or in another suitable format such as a netlist and timing constraints for a particular FPGA manufacturer's computer aided design (CAD) tools. Core vendors normally also supply substantial documentation and test sets for their design. Core vendors may sell direct to the “Designer” or may have a marketing agreement for the FPGA vendor to distribute their product. Even if customers purchase directly from the core vendor they are likely to find out about the core through the FPGA vendors web-site where there will be a comprehensive catalogue of cores which work with the vendors FPGA chips. FPGA vendors also generally provide intellectual property (IP) cores which can be incorporated in customer designs for their chips. These include simple functions such as adders and multipliers which are generally provided free of charge and more complex functions such as PCI bus to interfaces which are provided for a substantial fee. In some cases FPGA vendors license and resell cores from third party core vendors.

The “FPGA Vendor”—designs and manufactures FPGA chips.

The “CAD Software Vendor”—designs and sells CAD software tools. These include “Implementation Tools” which map netlists describing user designs into bitstreams which can program FPGAs. Implementation tools include place and route and bitstream generation tools. The complete design flow also requires higher level synthesis and simulation tools. Today, implementation tools for a given FPGA are generally only available from the FPGA vendor. There is a general trend for FPGA companies to provide more and more of the complete tool flow. For the purposes of our model we have separated the functions of software vendor and FPGA vendor because marketplace dynamics may well force a separation of the functions in the future.

The “Trusted External Party (TEP)”—or “trusted third party” is an organization which all parties to the transaction are willing to trust to behave fairly. Trusted third parties are common in cryptographic protocols—for example certification authorities sign public keys issued by websites to indicate that the organization issuing the key is actually entitled to use it. As an example when one visits Amazon's website and wishes to buy a book and needs to set up a secure connection to transfer a credit card number it is a certification authority such as Verisign corporation that guarantees that the public key obtained from the website which purports to be that of amazon.com actually is from amazon.com. In the context of FPGAs, the FPGA vendor is likely to act as the trusted external party since they will have existing business relationships with all the parties to the transaction. However, since the trusted third party role is a distinct one and need not be fulfilled by the FPGA vendor it makes sense to describe the protocols as if the trusted third party is a separate organization.

The FPGA Design Process

FIG. 1 shows the relationship between the parties in a conventional FPGA business model and design flow. In this case there is no trusted external party and FPGA bitstreams are transferred directly between designer and FPGA customer (who are normally within the same organization) and the bitstream can configure any FPGA of the correct type.

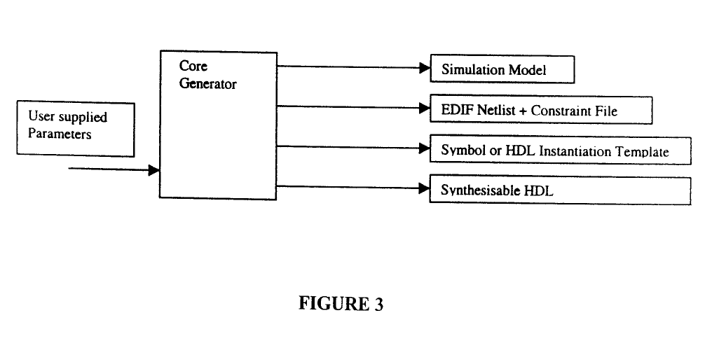

FIG. 2 shows a novel business model of the present invention in which a trusted external party is involved in bitstream creation. In this model core vendors turn over sensitive information about their intellectual property to the trusted third party rather than the FPGA designer. The trusted third party manages compilation of the overall design to create bitstream information. In this model FPGA chips require customized bitstreams and the trusted external party (TEP) is requested by the FPGA customer to create bitstreams for each FPGA chip. Thus the trusted third party can collect accounting data about how many chips a given IP core has been programmed into by a given customer and also how many times a given FPGA has been configured.

Where a user design incorporates one or more “cores” or design elements from third party vendors or the FPGA chip vendor problems arise in protecting intellectual property. FIG. 3 shows a simplified model of “core generator” software supplied by core vendors and accessed by the designer. Normally, the user will run CAD tools provided by the FPGA vendor to create a bitstream from high level design files. However, core vendors may not wish to provide complete design files to the user—since this would allow the user to modify the vendor's core and circumvent any copy protection mechanisms. Instead core vendors may choose to provide behavioral simulation models for their core which allow for design verification but not implementation or “encrypted” cores which can be processed by CAD tools but cannot be easily viewed or modified by the user. Altera Corporation, a major vendor of FPGAs, provides encrypted cores for evaluation purposes, these cores can be simulated to make sure they have the desired functionality but they cannot be used to generate bitstreams and the source code cannot be viewed. Once the user buys a license to use the core the unencrypted data is provided. This system is described in the application note “Evaluating AMPP and MegaCore Functions,” AN-125, April 2000, available from Altera Corporation. The design flow for another commercially important core generator product is described in “Core Generator.™. System 2.1i User Guide” dated 1999 and available from Xilinx Corporation. Both these documents are incorporated by reference.

At some point a complete bitstream for the entire design including all the cores must be created. To achieve this all design files, including those relating to bought in cores must be presented to the CAD tools-however the various parties to the design may not trust each other. For example, if the user is to run the CAD tools to create the final bitstream they must have complete design files from all the core vendors- and core vendors might worry that the user would circumvent their copyright protection mechanisms. If a core vendor is to run the CAD tools then the user must supply the core vendor with design files for their section of the design, and, if there is more than one core involved the vendors of the other cores would need to supply their competitor with their own design information. Where FPGA vendors offer their own cores directly to customers, FPGA users and independent core vendors may not wish to give the FPGA vendor design information.

One way to resolve this problem, shown generally in FIG. 2, is for a trusted external party (TEP) to receive design information from all parties, run the implementation tools and take responsibility for bitstream generation. Although some parties may prefer not to disclose design information to the FPGA vendor there are practical reasons for the FPGA vendor adopting this role. Firstly, they will likely have a business relationship with all the core vendors through cooperative marketing arrangements as well as with the FPGA user. Also, FPGA vendors develop the majority of the CAD software needed to program their products in house and are thus well placed to modify the CAD flow. FPGA users and core vendors, in fact, already trust the FPGA vendor with their intellectual property in that they regularly process it through software tools developed by the FPGA vendor. Finally, FPGA vendors are large and financially stable organizations. In the ASIC world, organizations like the Virtual Component Exchange have recently emerged to facilitate trading IP by providing standard contracts and an electronic trading floor. It is possible that organizations might eventually become TEPs for FPGA IP cores.

In this model the core vendors and the FPGA user supply design information to the trusted external party who then runs CAD tools to create a final bitstream for the complete design. An attractive way to offer such a service is via servers on the TEP's internet site. Using a client-server model the FPGA vendor can run elements of their CAD suite on their own servers rather than on the customers computer transparently via the internet. Today almost all FPGA customers and designers use computers with a high bandwidth internet connection. FPGA design tools are becoming increasing reliant on having a continuous connection to the internet available to provide help information and software patches. Today, a commercial “Application Service Provider” (ASP) service called Toolwire (www.toolwire.com) offers access via the internet to logic synthesis tools for FPGAs and Xilinx's “WebFitter” product as described on their website (www.xilinx.com) provides free online access via the internet to a fitting tool for its complex programmable logic device (CPLD) products running on Xilinx's servers.

Using this client-server technique the FPGA vendor can create a nonencrypted FPGA bitstream file and store it locally. This can be done without core vendors disclosing design information either to each other or to the end-customer. However, if the standard non-encrypted bitstream file is then supplied to the end customer there is nothing to prevent them configuring an unlimited number of FPGA chips with the design. What is needed is a cryptographic technique to allow per-use royalty collection on the final bitstream.

Pay Per-Use Configuration

In order to protect FPGA bitstreams from pirates who simply copy bitstream files and use them to create “cloned” products several cryptographic techniques have been devised by the assignee of the present invention. The problem of enforcing a pay per-use scheme for FPGA designs is similar in that it must also ensure that a configuration file created for one FPGA chip cannot be used to configure many chips. However, an important difference is that the cryptographic protection is intended to restrict the actions of the FPGA designer and the FPGA customer rather than a pirate.

Cryptographic schemes are generally based on secret information (“keys”) which in this case must be stored on the FPGA chip itself. Anyone who knows the cryptographic key on which the security scheme is based will, in general, be able to defeat the scheme. In the case of an FPGA bitstream created from several cores provided by third parties, some library elements provided by the FPGA manufacturer and design elements created by the FPGA customer access to keys is an important issue. As noted above the FPGA customer may not want their design to be accessed by core companies and core companies may not want their designs to be accessed by their competitors or the FPGA customer. One solution would be to have several keys all of which had to be present to “unlock” the design or to protect different parts of the design with different keys. A simpler solution is for a TEP to secure the design with a key known only to itself. A practical benefit of this approach is that the FPGA manufacturer can easily embed a secret key into the FPGA chips during the fabrication or test process on behalf of the TEP whereas core vendors will normally never have the chips in their possession.

One scheme for providing encryption support for a pay per use scheme for FPGA intellectual property cores involves the FPGA manufacturer implanting a unique identification code and secret cryptographic key in each chip during manufacture on behalf of a trusted external party (TEP). This could be done using a laser to cut specially provided metal wire segments. For example a cut wire segment would not conduct current and could be considered as a “0” and an uncut wire segment as a logic “1.” An array of these segments could represent a binary number such as a cryptographic key or serial number. The TEP can maintain a database of chip identification codes and their associated secret keys. The amount of disk space required to store this data is minimal: assume that 10 million chips a year are sold and a 64-bit (8 byte) identification code and 128 bit (16 byte) secret key are embedded on each chip for a total of 24 bytes of data per chip-then 240 M bytes of disk space are required to store the information. Today, 40G byte hard disks are available at low cost. In fact, on a high end PC, it would be quite practical to store the entire database in DRAM memory to allow very high speed access.

Recent FPGAs have been provided with a Joint Test Action Group (JTAG) serial interface for testing and configuration purposes. JTAG is standardized by the Institute of Electrical and Electronic Engineers as IEEE standard 1149.1. JTAG allows for data to be sent to the FPGA and also for data in registers within the FPGA to be read out. JTAG is flexible enough to allow complex interactions between a computer and the FPGA. In the context of this configuration scheme, during manufacturing, the JTAG interface on the FPGA is connected to a computer which is itself connected to the internet. Many other configuration interfaces to FPGAs apart from JTAG have been suggested and are in use: while JTAG is an attractive option it will be obvious to one skilled in the art that the techniques described here could be used with other kinds of interface to the FPGA. Software on the computer communicates with the FPGA manufacturer's servers. The FPGA customer provides information to the software to allow identification for billing purposes, they also provide information to the software to allow the correct design bitstream file to be identified.

Each time an FPGA is to be configured the computer accesses it via the JTAG interface to determine its identification number. It then sends a request to the TEP's server with the FPGA identification number, billing information for the FPGA customer and identification of the design to be downloaded. The TEP's server then looks up the correct encryption key for that particular FPGA chip in its database, encrypts the bitstream file appropriately, and supplies the encrypted bitstream to the customer's computer for downloading into the FPGA. This transaction results in a charge to the customer which includes license fees for any cores included in the bitstream and any service charges from the TEP. The TEP's server updates the customer's account information with the transaction details and also credits the accounts of the core vendors.

It will be apparent to one skilled in the art that there are several alternative schemes for collecting accounting data for the configuration of a core into the FPGA once the basic cryptographic support is in place. For example the user computer may contact core vendor systems directly to obtain authorization codes to use cores in the design. These codes could give permission to use the core once or many times. The authorization codes could be presented to the TEP at the time of bitstream generation. Another alternative is that the TEP itself buys licenses to use the cores in volume and acts as a distributor selling them on to its customers.

Since the FPGA bitstream is encrypted with a secret key known only to the FPGA chip and the TEP, the customer cannot decrypt the bitstream to determine the design information. Further, the bitstream supplied to the customer will only correctly configure a single FPGA. Thus the customer must purchase a new bitstream for each FPGA chip he wishes to configure with the design and hence pay for each use of any intellectual property cores included in the bitstream.

Pay Per-Configuration

A further advantage for the FPGA manufacturer of taking control of configuration is that it gives them more flexibility in component pricing since they can also obtain revenue every time the chip is configured. FPGA chips, in general cost much more to manufacture than ASICs of equivalent density, because of the area overhead of programming circuitry. The advantage of FPGAs is that they allow the possibility of upgrading designs in the field and can be used without paying high up-front tooling charges which are required for mask programmed parts.

The ability to charge for configuring FPGAs as well as the silicon itself allows FPGA vendors to match their charges with the benefits of the technology. For example, they could choose to reduce the price of the chips themselves but charge for each time they are configured. FPGA manufacturers already offer “low cost” product ranges targeted at high volume applications. An attractive option is to introduce a low cost product range with enforced pay-per-configuration where the “full-price” product range has a standard configuration mechanism. As well as “pay-per-configuration” to reflect the benefit of re-configuration in the field it is also possible to “pay-per-design” to reflect the benefit of the product customization and inventory management offered by programmable parts.

This low cost product range would reduce the initial cost advantage of ASIC technology making it more likely that FPGAs would be deployed. If a customer then needed to upgrade their products in the field the FPGA vendor could make an additional charge for this. The ability to charge for configuration will be of particular advantage to emerging companies who sell FPGA technology as “Silicon IP”—that is as an intellectual property core which can be included on larger “system chips” designed by their customers—rather than producing FPGA chips themselves.

Network-Based IP Protection

In a first detailed embodiment of this invention a simple network based scheme is provided under which a TEP acts to facilitate “pay-per-use” revenue collection on intellectual property cores.

In this scheme the core vendor creates a “core generator” application which is hosted by the TEP on a server computer accessible via a network. Preferably, the core generator is accessed by the designer via a web page and the server computer is connected to the internet. Documents describing conventional core generator software from the leading FPGA vendors Xilinx and Altera were referenced above. The core generator is accessed by the user who enters any required design parameters (for example, bus widths for a bus interface core). The user identifies themselves to the core generator by means of a username and password and a secure connection is created between the user's computer and the website. The website then supplies design information to the user including simulation files for the core, documentation and code to instance the core in an HDL design. Sensitive design information such as netlist files created by the core generator are not supplied to the user but are retained by the TEP.

Based on the information supplied the user can complete and verify their design at the logical level using simulation. When they wish to generate a complete FPGA configuration for the design they run the FPGA manufacturer's implementation tools. However, the necessary files to actually create the core on an FPGA have not been supplied to the user, rather they were retained by the trusted third party.

In another embodiment the core-generator tool is accessed by the FPGA designer from the core provider's website rather than the TEP's website but the sensitive design files are transferred by the core provider either immediately or at a later time to the TEP's server rather than sent to the FPGA designer.

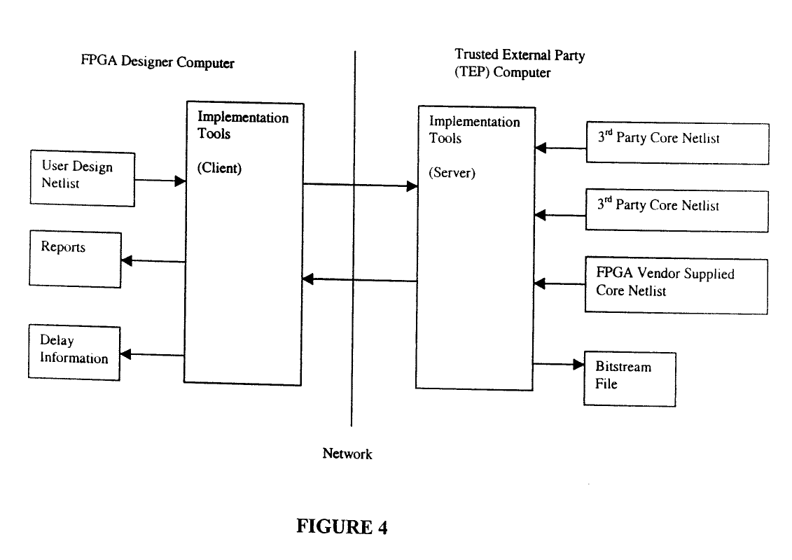

In a first component of this scheme shown generally in FIG. 4 the implementation tools interact with the TEP via a network. Conveniently, the interaction takes place over the internet and standard security protocols such as secure sockets layer (SSL) are used to protect information as it passes between the computers. When the designer runs the FPGA vendor's CAD tools information on their section of the design are supplied to the TEP's computer which then combines them with the information from the various core vendors to create a complete design. The resulting timing information and log report files are provided to the user but the bitstream file is held in a design database on the TEP's server computer. The designer is supplied with an identifier which allows the design information to be located on the TEP's server. As well as the bitstream file the design information stored in the TEP server includes a list of all licensed cores used in the design and details of any FPGA designers and FPGA customers allowed to access the design.

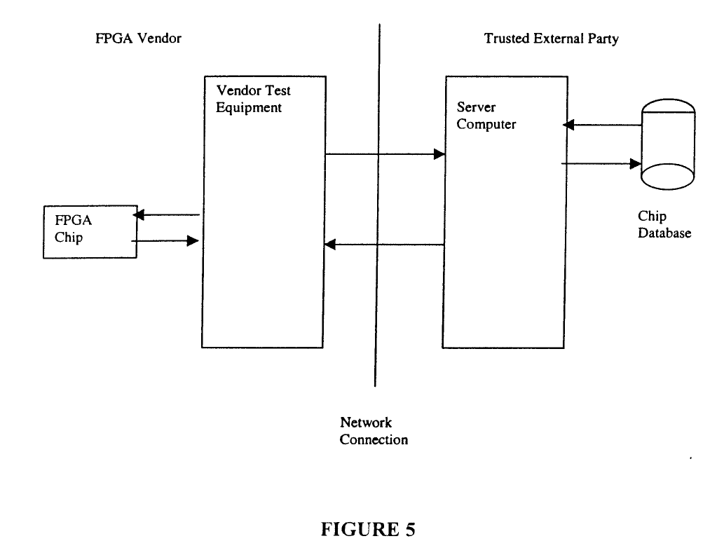

In a second component of this scheme shown generally in FIG. 5 the FPGA manufacturer interacts with the TEP. This interaction occurs during chip production and is independent of the interaction between the TEP and the FPGA designer. The purpose of this interaction is to establish a shared secret between the FPGA chips and the TEP's server allowing secure communication between the chips and the TEP after they leave the FPGA manufacturers facility. In this embodiment each FPGA has on chip nonvolatile memory in which the TEP can store a secret key and unique chip identification number. The chip will report the unique chip identification number on request but will not report the secret key. Many technologies are available to store small amounts of secret information on an FPGA chip including antifuse and various forms of EPROM. In this transaction the TEP can specify a key to be stored in the FPGA or alternatively the TEP can be told the key selected by the FPGA manufacturer or information related to the key. The TEP maintains a chip database on its server allowing it to find the key for a particular chip based on the chip's identification number. The chip's identification numbers may be sequential integers but they do not have to be.

In one embodiment the identification numbers are 64-bit random integers and identification numbers are screened against a list of previously used numbers to eliminate duplicates before programming them onto the chips. In another embodiment it is assumed that the number of possible identification numbers is so large compared with the number of FPGAs of a particular type manufactured that duplicates are so unlikely to occur that they are not of concern. In an embodiment many or all FPGAs have the same chip key but each has a unique identification number. In an embodiment the secret key may be embedded in maskwork to make it very hard to discover whereas the identification number is embedded using laser programmed fuses. In an embodiment in order to reduce the number of laser fusible links or other nonvolatile memory bits required each FPGA has a unique chip key and calculates an identification number when required by encrypting a particular integer (for example 0) using the secret key. In an embodiment the chip key programmed onto the FPGA is created by encrypting the identification number using triple-DES with a secret key known to the TEP. This allows the TEP to determine the key for any given chip based on its identification number without maintaining a database.

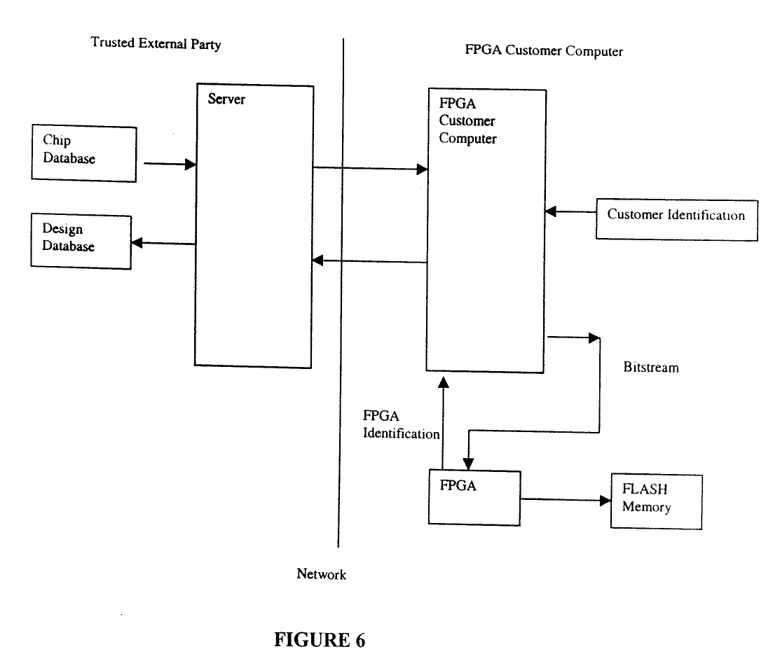

In a third component of the scheme shown generally in FIG. 6, when the FPGA customer wishes to configure the design into an FPGA they connect the JTAG interface on the FPGA to a computer, this computer may be part of the test equipment for checking each manufactured board. The computer reads out identification information from the FPGA and opens a connection to the TEP's server. Conveniently, the connection is over the internet and is secured using the secure sockets layer (SSL) protocol. The secure connection provides identification of the FPGA Customer to the TEP and vice versa. Normally, the user would identify themselves via a username and password and the TEP would identify itself via a public key certificate signed by a trusted authority. This identification process is identical to that used by electronic commerce internet sites and is not discussed further.

The computer then passes the FPGA identification and bitstream identifier to the TEP's website which looks it up in a database relating FPGA identification codes to secret keys stored on the chip during manufacture. In another embodiment, instead of using a database, the TEP's computer may calculate the secret key from the identification number. The TEP then locates the bitstream corresponding to the bitstream identifier, checks that the FPGA customer is in fact allowed access to that bitstream, encrypts the bitstream with the secret code for that particular FPGA and sends it through the network to the user's computer. The FPGA customer's computer then supplies the encrypted bitstream information to the FPGA via JTAG. The FPGA customer may access the bitstream as it crosses over the JTAG interface but without knowing the secret key shared by the FPGA and the TEP it is impossible to decrypt the bitstream in order to reverse engineer it. Further, the bitstream will only work with one FPGA so copying the bitstream to use with other FPGAs is pointless. The FPGA, in turn, programs the encrypted data into local nonvolatile memory—for example, a serial EPROM.

The scheme above, using JTAG to determine the FPGAs identification number and using the FPGA to program data into an external FLASH memory, is particularly convenient but one skilled in the art will realize that there are many ways of finding the chips identification number and storing the encrypted bitstream. In an embodiment the FPGA customer computer obtains FPGA identification numbers indirectly, for example by scanning barcodes on the tubes containing the chips to obtain a lot number and accessing a database of identification numbers provided by the FPGA manufacturer. In an embodiment the FPGA customer programs the encrypted configuration information into nonvolatile memory directly rather than passing it through the FPGA chips.

At this point the FPGA has an encrypted design which it can load and implement, however, since the design is encrypted with the key for this particular FPGA and all FPGAs have different keys the user cannot use the bitstream file with any other FPGA.

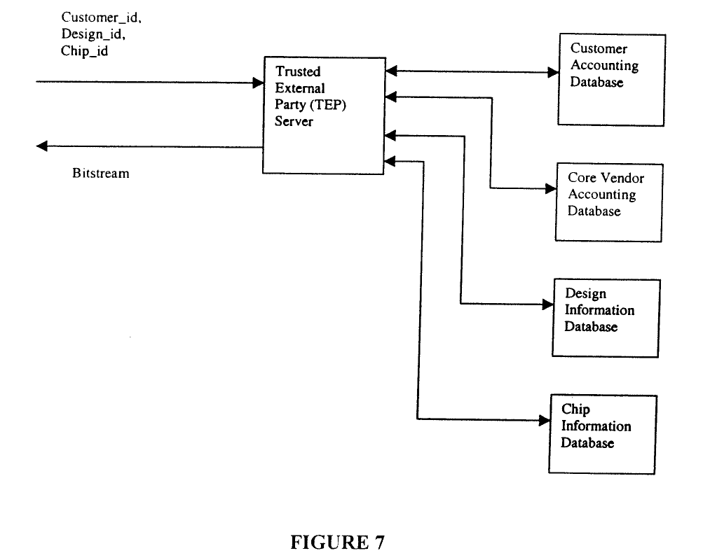

in a fourth component of the scheme shown generally FIG. 7, the TEP's computer updates accounting information each time a bitstream is created for an FPGA chip. The FPGA customer presents information to the TEP server identifying the customer, the chip to be programmed and the design bitstream to be used. The TEP server consults the design information database to determine which cores are included in the bitstream supplied and updates the core vendor accounting database to reflect the royalties payable to the core vendors and the license charge to the customer. As well as charging any core vendor royalties to the user account the FPGA vendor may, of course, charge a fee for its service in supplying the encrypted bitstream or a royalty on any of its own cores included in the design. The TEP server also checks that the customer is allowed to make use of the design bitstream requested. In an embodiment the TEP can determine the FPGA type from the chip identifier and checks that the bitstream is compatible with the particular FPGA.

In an embodiment the TEP checks that the customer's credit limit is not exceeded before going ahead with the transaction. In an embodiment the customer buys licenses in blocks from core vendors and the TEP merely maintains a count of available licenses for a given core, decrementing the count each time the core is configured onto an FPGA rather than collecting license fees. Many additional variations on the described business relationship between the TEP, core vendors and customers will be apparent to one skilled in the art after reading this disclosure and are intended to fall within the scope of the present invention.

Trusted Software Based IP Protection

In the previous embodiment of the invention security was obtained by holding secret design information on a server computer managed by the TEP in order that it was never accessible by the other parties. While this is an increasingly viable technique and is likely to be a preferred technique in the future in the present state of networking technology there may well be resistance to requiring network connections for critical tasks such as configuring FPGAs during manufacture. There may also be resistance from FPGA designers to supplying design information to the TEP. In the present marketplace IP providers have relatively weak commercial leverage compared with FPGA designers and customers so techniques in which designers do not have to release design files to the TEP are of interest.

An alternative to using a TEP web server in the IP licensing scheme is to use trusted software containing TEP secret information which runs on the FPGA designer's and customer's computers. Software is, in general, vulnerable to hacking through decompilation and tracing but various techniques are available to make it more resistant. In addition hardware devices such as smartcards or tokens provided by the TEP can be connected to the designer or customer's computer to undertake cryptographic tasks and shield secret information such as cryptographic keys. Nevertheless, use of secure software rather than the networking architecture of the first embodiment can be viewed as a trade-off between absolute security for the IP core providers and TEP against increased ease of use and security for the FPGA customer and designer.

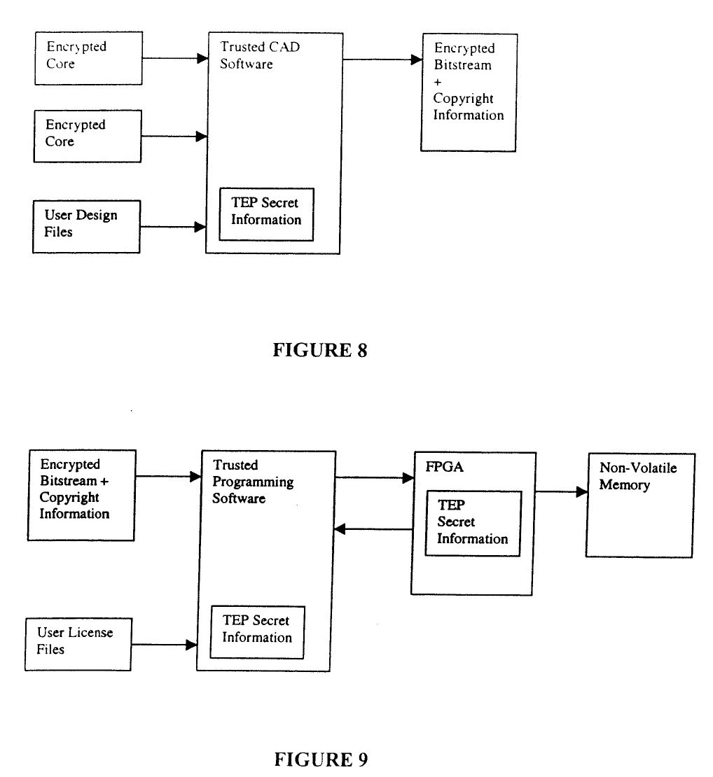

FIG. 8 shows how trusted CAD software can be used by the designer. Core vendors now supply full information for their cores but in an encrypted format. This prevents the designer from reverse engineering or modifying the designs but allows the CAD software to process them. Encrypted design files are, as noted above, already in use by FPGA suppliers for core evaluation. A detailed description of one such scheme is provided in U.S. Pat. No. 5,978,476 assigned to Altera Corporation which is incorporated by reference. An EDIF file representing netlist information for a core is a normal text file and can simply be encrypted using a cipher such as DES in cipher block chaining mode—this is merely an example of one possible scheme. Encryption can be done by the core vendor prior to supplying the core and the trusted CAD tools can then decrypt the file. Preferably, a separate hardware token supplied by the TEP is connected to the designer's computer and used to perform the decryption operations on the CAD file.

After decrypting any files owned by third parties to obtain a complete design database the CAD tools can then create a bitstream file. The bitstream file is also encrypted so that, although it resides on the designers computer and can be distributed at will by the designer it is impossible to reverse engineer design information from it or use it directly to program FPGAs. In one embodiment, if the CAD tools do not require to decrypt any design source files they will assume that the designer has full rights to the design and compile the design to a standard nonencrypted bitstream.

In an embodiment, as well as configuration information for the FPGA the encrypted bitstream file includes licensing information for the various cores which were decrypted. This might include an identifier for the core vendor, the core name and the number of times it was instanced in the design, it may also include additional parametric information for the core since some cores may have various options which affect the license fee.

In order to create bitstream information for an FPGA (as shown in FIG. 9) the FPGA customer requires the encrypted bitstream file and trusted configuration software supplied by the TEP. In an embodiment, the trusted software communicates with the FPGA through its JTAG interface. A consideration is that the FPGA customer can monitor any communications across the wires that connect the FPGA to the customer computer so it is desirable to cryptographically secure sensitive information like bitstreams as they are transferred from the trusted software to the FPGA.

The function of the trusted configuration software is to convert the encrypted bitstream file from the design tools into a bitstream file capable of configuring a particular FPGA and to download the file into the FPGA. The trusted configuration software contains TEP secret information to allow it to decrypt the encrypted bitstream file and re-encrypt it for a particular FPGA. Preferably, for additional security, the secret information is stored on and encryption is carried out by a hardware token or smartcard coupled to the software running on the user computer.

Since, one goal of this embodiment is not to require a network communication with the TEP during the configuration process an alternative means of enforcing pay-per-use licensing is required. The mechanisms required are similar to those required in equipment like postage meters and pay-per-view television and analogous to metering of electricity. One approach is for the customer to pre-buy blocks of licenses. The trusted software would then manage these licenses decrementing the available license count every time a chip was programmed and refusing to program chips once the licenses were exhausted. Various techniques are available for transferring additional “credit” into the licensing unit. Alternatively, the software could record license usage information in a secure fashion and access could be provided on an occasional basis to allow the information to be read—either directly from the equipment or via a network.

Licensing could be done on a per-design basis with the TEP collecting revenue and distributing it to various core vendors. This simplifies the process and means that only the TEP and the customer know which cores are used by the customer. Alternatively, licenses could be bought on a per-core basis directly from the core vendor and the TEP software would check that licenses for all necessary cores were present. Some designs may contain more than one “instance” of a particular core and so available license counts may have to be decremented more once when a chip is configured. Per-core licensing increases the flexibility with which a customer with a large number of different products containing FPGAs can use licenses-since licenses are not associated with a given design at the point of purchase. The techniques are not incompatible and there is no reason why some cores used in a design might be purchased via the TEP and others directly from the core vendor.

Layered Encryption

In the case where the FPGA manufacturer installs a key on the chip during manufacture, for example by laser programming a random number onto the chip they may prefer not to make any record of the key to reduce the chance of unauthorized access to key information. The manufacturer may also implant a chip identifier which is not secret. In the subsequent discussion “chip_key” and “chip_identifier” are used to refer to this data embedded.

It would be advantageous, therefore, if the intellectual property protection scheme of this invention could be implemented on chips which had an on chip secret key to secure bitstreams but the value of the on-chip secret key was not known to the TEP.

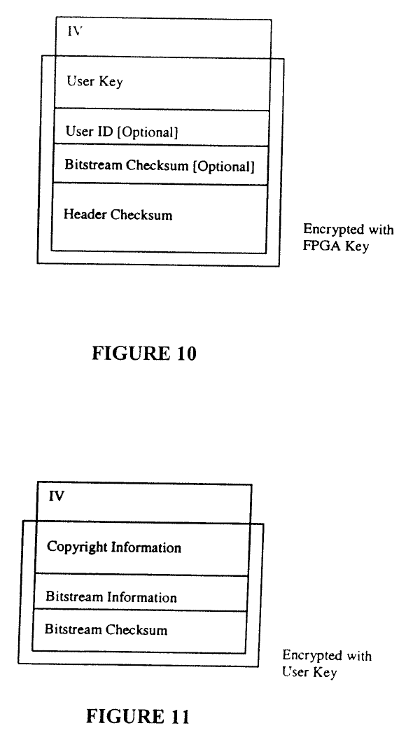

This can be done as follows. After concluding test on a packaged the FPGA manufacturer presents a bitstream header to the FPGA for encryption using the on chip secret key. One structure for such a header, after encryption, is shown in FIG. 10.

The first field of the header is an initial value (IV). The IV is used in Cipher Block Chaining encryption to initialize the feedback loop. Preferably the IV is a random number created by a random number generator on the FPGA. The IV need not be kept secret and is output unencrypted by the FPGA. The use of IVs is specified in industry standards related to CBC mode encryption and increases resistance against some forms of cryptanalysis, CBC mode encryption is covered starting on page 193 of the Schneier textbook referenced above.

The second field in the header is a user key (referred to as user_key). The user key is used to protect the bitstream information. The second and subsequent fields are output encrypted in CBC mode using the FPGA's secret key.

The third field in the header is optional and is the user FPGA identifier (referred to as user_identifier). This field is used in embodiments where the FPGA itself does not provide a chip_identifier accessible from off chip or where the format of the chip's identifier is inconvenient (for example, if the user wanted a unique incrementing identification number and the FPGA manufacturer used random 64-bit integers as chip identifiers).

The fourth field in the header is also optional and is the bitstream file checksum for the user design to be protected. This field is useful when it is known at the time the header is generated what bitstream file is to be protected.

The fifth field in the header is a cryptographic checksum. In the preferred embodiment this is a message authentication code (MAC) generated from the CBC encryption process (as described on page 456 of the Schneier textbook cited above). In an alternative embodiment a separate cryptographic hash function is used to generate the checksum. The purpose of the fifth field is to allow the FPGA to check that the header is valid and has not been tampered with or corrupted.

Preferably this header file is created while the chip is on the tester since every time the chip is handled there is a chance of damaging the package leads. The FPGA chip is presented with the user_key and optionally the user_identifier and bitstream file checksum (fourth field) via JTAG and creates the encrypted header file of FIG. 10. In an embodiment the test machine c emulates an external nonvolatile memory and capture the data so the FPGA acts exactly as if it was storing a user design securely. Preferably, the FPGA may be instructed to output the information over JTAG.

Test happens in the FPGA manufacturer's secure facility so there is no problem with unauthorized parties monitoring the connections transferring secret information such as the user key to the FPGA. The tester obtains the encrypted header information output by the FPGA and saves it in a file along with the chip serial number and the user key supplied to the FPGA in a separate file which is provided to the TEP. The chip can now be sold as normal.

In one embodiment customers receive the encrypted header file for all the chips they have ordered. The encrypted header files can only be decrypted by the FPGA chip that created them and so they do not have to be kept secret. Header files might be supplied on a CD-ROM or other electronic media along with the chips or supplied separately for example as an e-mail. Since the header files are very small it is quite practical to present many header files to an FPGA, the FPGA will only react to the correct header since the others will have incorrect checksums when decrypted with the FPGA's key. The fact that many headers can be presented reduces the matching burden in finding the right header for a given chip. For example headers for all chips delivered in the same tube could be presented so there was no need to track individual chips to find the right header.

In a preferred embodiment the customer reads the chip_identifier via the JTAG interface once the chip is installed on a printed circuit board. The customer then requests the header file from the TEP's web server corresponding to the chip_identifier.

When an FPGA loads a header file that it created it decrypts the user_key and user_identifier. At this point the FPGA has a user identifier and user_key pair loaded in on-chip registers, these are also known to the TEP and can be used to establish secure communication with the TEP. In most embodiments the user_key and user_identifier are loaded into conventional, volatile registers which lose their value when power is removed. Preferably, the user identifier register can be read via JTAG or from the user design on the FPGA but cannot be written from JTAG or the user design configured onto the chip. Preferably, the user_key register is inaccessible via JTAG and the user design. This technique allows the TEP to obtain the main benefits of being able to specify a key and identifier to be programmed into the FPGA even when logistical or technical reasons make this inconvenient.

In a preferred embodiment the user-key is different for each FPGA. In another embodiment the TEP uses the same user key for all FPGAs. In another embodiment the user key is obtained by encrypting the user identifier with a secret key known to the TEP.

This technique of layered encryption can be used with the network based and trusted software based IP protection schemes outlined above.

Network-Based Configuration

In an embodiment where the configuration software is connected via a network to the TEP's website and the design bitstream information is stored on the TEP's website configuration takes places as follows. The configuration software requests the chip identifier via the JTAG interface and supplies it to the TEP website. The TEP website then supplies the matching encrypted header file which is downloaded to the FPGA via JTAG. At this point the FPGA has the user_key and user_identifier available in internal registers.

The TEP website can also determine the user_key and user_identifier from its own databases given the chip identifier. Alternatively, the FPGA can be asked to report the user_identifier via JTAG and the user_identifier can be supplied to the TEP website. The TEP server then performs the accounting actions as in the previous network based embodiment. Assuming the FPGA customer is found to have access to the design and licenses for any cores used the TEP server then encrypts the design information using the user_key and downloads it to the configuration software for transfer to the FPGA via JTAG.

Trusted Software Based Configuration

When trusted software is used and there is no network connection to the TEP server in order to create a complete bitstream for a particular FPGA the FPGA is asked to supply its chip identifier via the JTAG interface and is then loaded with the matching header information also via the JTAG interface.

A database of header files and associated chip identifiers can be supplied on CD-ROM or other media and as they are encrypted there is no need to keep them secret. This transaction involves transferring a very small amount of data. The FPGA is then asked for its used identifier, again via JTAG. From the user identifier the configuration software determines the user key. In the embodiment where the TEP uses a single user key for all FPGAs the user key is simply embedded in the configuration software. In the preferred embodiment where each FPGA chip has a different key the configuration software may obtain the key from an encrypted database supplied on CD-ROM. In the embodiment where the user key was calculated by encrypting the user identifier using a secret TEP key the trusted configuration software has the TEP key embedded in it and repeats the calculation. As noted above, preferably the trusted software makes use of a hardware token or smartcard to store sensitive information such as TEP key's and perform cryptographic functions.

The trusted configuration software now knows the user_key for the FPGA it also has access to an encrypted bitstream file containing the user design and copyright information on any cores used. The key necessary to encrypt this bitstream file is embedded in the trusted software. The software decrypts the bitstream file, accesses the copyright information and checks that licenses are available. If they are available it decrements the number of available licenses. It then re-encrypts the bitstream with the user key for the FPGA and transfers it over JTAG to the FPGA.

FPGA Actions

The FPGA then decrypts the bitstream using the user key to obtain the configuration information for the design which is loaded into configuration memory. The FPGA must also store the design into external nonvolatile memory so that it can be accessed at a later time. In an embodiment the FPGA encrypts the design using the chip key and writes it into external nonvolatile memory. In an embodiment the FPGA decrypts from the JTAG interface as it is received, re-encrypts the information using the chip key and writes it out into the external FLASH memory without storing it in on-chip configuration memory.

In an embodiment the FPGA makes use of an area of on-chip memory which is not configuration memory to support the download process.

In an embodiment the FPGA writes out the header file information using the chip key and writes out the bitstream information encrypted using the user key so the structure of the information received over JTAG is preserved in the external nonvolatile memory.

In an embodiment the bitstream file format includes a section for copyright information on the cores and the design itself and this information is written out in plain text although the cryptographic checksum is calculated on the whole bitstream file including the copyright information so that any alterations to the copyright information are detected.

Comparing Secured FPGA Bitstreams

When a problem occurs in equipment containing SRAM-programmed FPGAs, service engineers need to determine if the FPGAs have been configured correctly. If the FPGAs are loaded with unencrypted bitstreams it is easy for service engineers to read out the nonvolatile memory on the board and compare it with the correct design information to determine if it has been corrupted (due to a faulty memory or other error) or if an incorrect version of the design has been used. In some applications, for example electronic gaming machines, tampering with the design in the field is also a concern. The standard technique for determining if tampering has occurred is to read out the design bitstream and compare it bit for bit with the “correct” design bitstream. Distributing bitstreams is also much simplified if every FPGA loads the same bitstream.

Although there are effective cryptographic techniques (such as message authentication codes and secure hash algorithms) for determining if tampering or corruption has occurred FPGA customers may be resistant to making use of them and prefer the simplicity of reading back and comparing memory contents. In some cases regulations might make it difficult to change to a different technique even if the customer was convinced of its effectiveness. For these reasons it would be desirable if the security mechanism allowed tamper or corruption detection by straightforward comparison of encrypted bitstreams—this implies that each FPGA should load the same bitstream.

However, as described above, in order to implement per-use charging for IP cores and prevent cloning of equipment containing FPGAs by copying bitstream information it is desirable that each FPGA must have a different secure bitstream.

Many of the advantages of each chip having the same bitstream can be made available through an embodiment of the invention in which the same user_key is used for many chips. The user_key may be associated with a given FPGA customer or FPGA designer or with a particular design—or their may even be a single user_key for the TEP. The value to an attacker of obtaining the secret key is increased the more designs it is used to protect so in a preferred embodiment the key is changed on a per-design basis. In this case the encrypted bitstream file can be created by trusted CAD tools using the TEP's secret key. This file does not need to be decrypted and re-encrypted for each chip. In a network based configuration scheme there is no need to transfer megabytes of encrypted bitstream each time a chip is configured.

In order to maintain the security benefits of bitstreams being unique for each chip an extra “bitstream header” component is added to the header information described in the previous section and shown in FIG. 10. The new information is shown in FIG. 11. Normally, when created by a TEP the original header information does not contain anything specific to a particular design- and cannot do so because it is created at the time the FPGA is produced at which point no information is available about the design it will eventually be used with. Similarly, the encrypted bitstream contains no information about the chip for which it is intended, and cannot do so because the implementation tools do not have that information available.

The “bitstream header” information links the original header to the design bitstream, the first field is the user_identifier (in an alternative embodiment the chip_identifier is used) and the second field is the checksum of the bitstream file. The additional header information is encrypted with the user_key which is known to the trusted configuration software but not to the FPGA customer. The FPGA customer cannot tamper with or decode the additional header information. The trusted configuration software or the TEP server creates the additional header. The FPGA is designed not to load bitstreams unless the additional header information is present—thus a complete configuration loaded into the FPGA chip consists of header, bitstream header and bitstream.

To load the configuration information the FPGA first loads the header and decrypts it using the FPGA_key. Assuming the checksum information indicates there is no problem it sets the user_key and user_id registers with the values from the header. The FPGA then loads the additional header information and decodes it with the user_key. Assuming the checksum on the additional header indicates there is no problem and the user_id obtained from the additional header matches that stored in chip's user_id register the FPGA goes on to decode the bitstream information. (In another embodiment the chip_id is stored in the additional header and compared with the chip_id stored on chip). If the ids do not match the FPGA concludes that the FPGA customer is trying to reuse a bitstream created for another FPGA in order to avoid per-use licensing and does not load the bitstream information.

The bitstream information is then loaded and decoded with the user_key. After loading, but before enabling the user design the FPGA checks that the checksum on the bitstream file matches that in the additional header. If they do not match the FPGA concludes that the user is trying to load a different bitstream file from the one for which the header was generated in order to avoid per-use licensing charges and disables the user design. In this case the FPGA may also clear the configuration memory and take other appropriate actions.

If the configuration information was received over JTAG then, assuming there were no problems detected, it may also be written out in encrypted form to external nonvolatile memory as described in the previous section.

Since the user bitstream is encrypted using the key supplied by the user every FPGA will have the same encrypted bitstream and it is possible for field personnel to determine the bitstream version and detect corruption simply by comparing bitstreams. Only approximately 32 bytes (256 bits) in the bitstream header in which the user key and user_id encrypted by the FPGA key is stored will be different from one FPGA to another. In this technique the FPGA's secret chip_key is used to secure the user cryptographic key rather than the bitstream itself.

Use of Layered Encryption by Parties Other than the TEP

In the previous section we discussed how an encrypted header file could be created in the FPGA manufacturer's facility for use by the TEP. It will be clear that, although this technique is advantageously used by the FPGA manufacturer it can, in fact, be used by anyone who has the FPGA chip in their possession at a given point in time and can make electrical connections to its pins. Obtaining electrical connections to the FPGA's pins is easy as soon as it is installed on a printed circuit board but requires specialist handling equipment otherwise.

Parties who have access to the FPGA at a particular point in time and may wish to establish secure communications with it at a later point in time after it has left their possession include distributors of FPGA chips, FPGA customers who wish to secure field-updates of FPGA programming information in their equipment or even end users of equipment containing FPGAs who wish to lock the FPGAs. An example of such an end-user might be a corporate IT department which buys a quantity of equipment containing FPGAs and wishes to prevent individual employees from accessing the programming information. It is easy for the manufacturer to access the chip during testing and it is also easy to access the chip once it has been added to a printed circuit board. It is less convenient to access the chip between the point when it leaves the manufacturer and is added to the PCB since the tester and handling equipment used by the FPGA manufacturer to access packaged chip is relatively expensive.

It is also possible for more than organization to act as a TEP for a given type of FPGA provided they can obtain access to FPGAs prior to shipment to their customers. If the FPGA manufacturer refused to cooperate by supplying access to chips during testing a TEP could even buy FPGA chips and resell them to its customers.

A particularly straightforward use of layered encryption is when the FPGA designer and customer simply wish to protect their products containing an FPGA from cloning and reverse engineering in the field. In this case the bitstream generation software must prompt for a user password (or a passphrase from which a password can be calculated) at the time the bitstream is created. As configuration files are created for individual FPGAs the configuration software prompts for the password again in order to present the password to the FPGA to create the header and in order to create the bitstream header itself.

Securing Software Download

This embodiment considers the case where an FPGA customer wishes to update bitstreams for FPGAs located in products sold to end users and deployed in the field. The products are connected to the internet or some other communications medium (e.g., fixed or cellular or wireless telephone network) and can communicate with a server in the FPGA customer's facility. For simplicity we assume that the design does not include any IP cores and the user posses a nonencrypted bitstream for the complete design. The general situation is shown in FIG. 13.

As previously discussed each FPGA contains a secret key (chip_key) installed during manufacture. The secret key is unknown to the end user and FPGA customer. When power is applied to the equipment containing the FPGA it loads bitstream information from a local nonvolatile memory. In this field-upgrade scenario the FPGA customer does not have physical access to the FPGA—thus they cannot simply download a new design via JTAG or the program the nonvolatile memory chip directly to change the design without the FPGA's cooperation.

During the equipment manufacturing process the FPGA customer causes the FPGA to create an encrypted header file containing a user_id and user_key known to the FPGA customer as discussed previously in conjunction with FIG. 10. Accessing the FPGA via JTAG is easy since it is mounted on a printed circuit board when the user_key, user_id (and other optional fields if required) information is loaded via JTAG the FPGA programs the external nonvolatile memory with the encrypted header information. This header information is stored in the external nonvolatile memory along with the remaining bitstream information.

After loading the design from local memory the FPGA has an active user design in its configurable logic and, as a result of processing the header information also has the user_key and user_id in registers within its cryptographic and configuration circuitry. These values constitute a shared secret with the FPGA customer allowing secure communication.

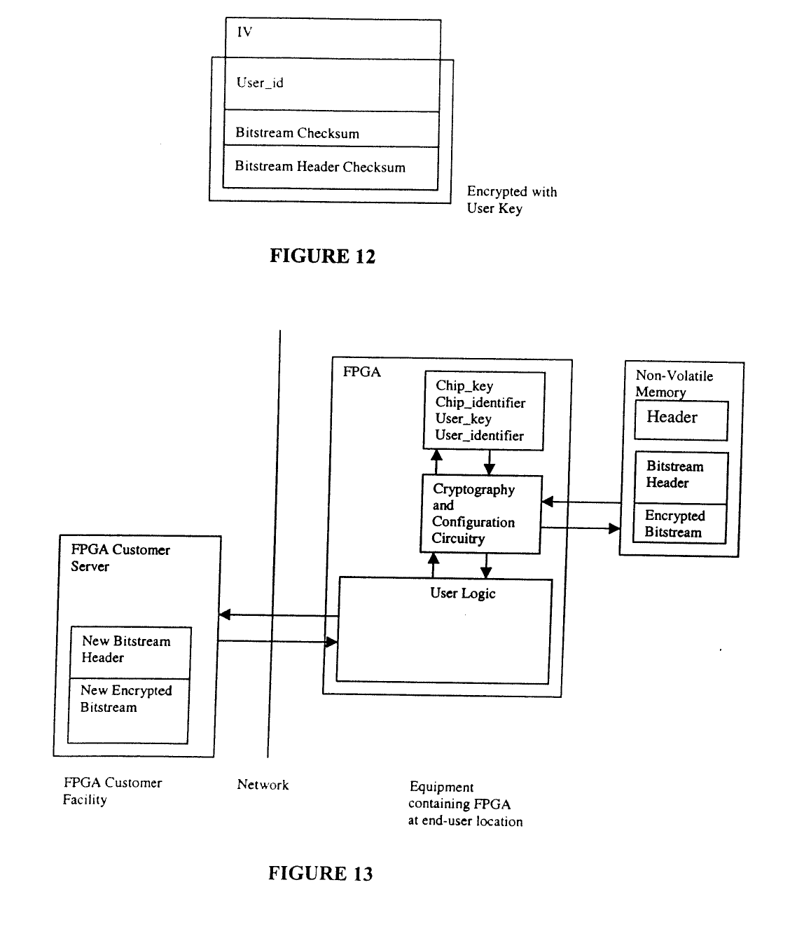

Preferably, the download mechanism allows for the user_key to be changed in the field. This can be done by extending the bitstream header of FIG. 12 to include a new_user_key field. When the FPGA loads the bitstream header and checked that the checksum is correct it knows that it was created by someone with knowledge of the user_key (since the bitstream header was correctly decrypted using the user_key). If the new_user_key field specifies a value different from the current user_key register the register is updated prior to decoding the bitstream information. After decoding the bitstream information the FPGA also saves the design to its external non volatile memory to update the header and bitstream header to reflect the new user_key.

When downloading bitstreams over a network connection it is preferable not to overwrite the existing configuration data in nonvolatile memory and on-chip memory as data is received. Only at the end of the entire transmission can the checksum be checked to see that the file has not been corrupted or tampered with in transit. Network connections are sometimes broken before the entire bitstream is transferred. If the existing configuration data in nonvolatile memory is overwritten as data is received but the new data is corrupt or incomplete the equipment no longer has a good configuration in nonvolatile memory to boot from if power is lost midway through receiving the data. If the on-chip configuration is overwritten as data is received the FPGA may implement incorrect or maliciously created configurations which cause the system to fail in an unrecoverable fashion.

For this reason in a preferred embodiment the new data is saved in a separate area of nonvolatile memory and when the final checksum has been received and it is known the data is not corrupt a markerise updated in the indicate that the new configuration is now current. At that point the old configuration can be erased. Preferably the marker should be updated in a single memory write since if power is lost midway through a more complex procedure the equipment may not be able to determine which configuration (old or new) to use. Once this is done the FPGA is “rebooted” to load its new configuration from the external memory.

There are many FPGA manufacturers and many possible nonvolatile storage technologies and architectures so there will necessarily be many variations on the protocol for downloading and switching between configurations. The document “Implementing Secure Remote Updates using Triscend E5 Configurable System-on-Chip Devices,” Application Note AN02, available from Triscend Corporation, Mountain View Calif. which is incorporated by reference gives details of managing the process for one particular chip and FLASH memory.

Layered Encryption for Software Download

In some applications it would be desirable that the encryption scheme can be applied in layers so that all parties to the transaction must consent before a reconfiguration takes place. For example, the TEP might has an interest in obtaining pay-per-use license fees for any IP blocks in the design. The FPGA customer might have an interest in making sure that no configuration is loaded into the equipment containing the FPGA that will cause it to operate in a dangerous or inappropriate manner, this is particularly important if the equipment is subject to type-approval from a regulatory authority. For example, a service-provider who had subsidized the equipment price to the end user might wish to ensure that the end user could not reconfigure the device for another service provider. Equally, the end-user themselves might wish to prevent any of the other parties reconfiguring and changing the functionality of the device without their consent.

If we look at the chain of interested parties from TEP to end-user it is clear that:

Parties further down the chain should be able to prevent parties further up the chain from downloading bitstreams directly into the equipment and thus changing its functionality from without their consent.

Bitstream files and passwords passing down the chain should be protected from access, modification and reverse engineering.

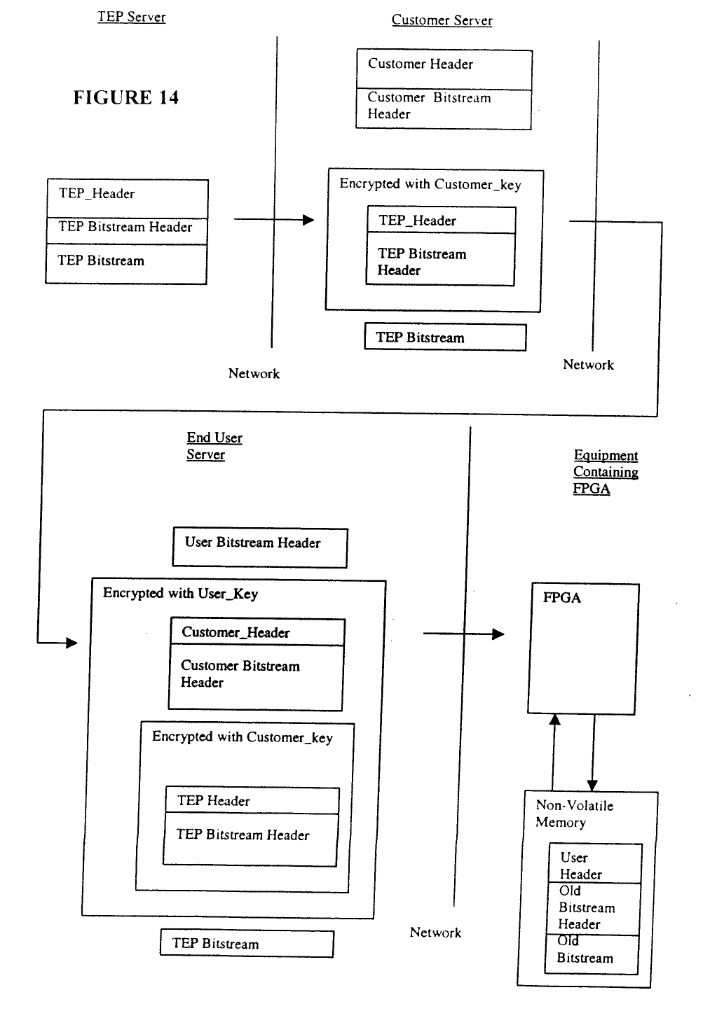

An embodiment of layered encryption which achieves this is illustrated in FIG. 14. In this case the TEP, the FPGA customer and the end-user all wish to control software downloads to the FPGA in the field. Layered encryption can be viewed as enclosing the bitstream data in a sequence of envelopes, each of which can only be removed with the cooperation of the party who added it.

To achieve this, when a download occurs it passes through the server computers of all the parties to the transaction in order with the final download happening from the end user. At each stage the servers add additional information. The scheme is designed so that only header information is added and encrypted at each stage, the bitstream itself is left unchanged from that supplied by the TEP. This is important since the bitstream may be several megabytes long whereas the headers are a few bytes each. Thus there is little penalty in encrypting and decrypting the header information many times but it would be expensive if the FPGA had to decrypt the bitstream many times.

Header files have the structure of FIG. 10 and are created by the FPGA when it is in the possession of the various parties. Since header files are encrypted using the secret fpga_key they cannot be decrypted by anything other than the FPGA itself.

When deployed in the field by the end-user the nonvolatile configuration memory for the FPGA contains only the end users header file. Thus, only the end users server which knows the corresponding user_key can download to the FPGA.

The end_user server receives FPGA designs from the FPGA customer to pass to the FPGA in the equipment. These designs contain the header information generated by the fpga_customer, which if loaded into the nonvolatile memory would allow the FPGA to determine the FPGA customers user_key. They also contain the bitstream header information used to lock the design to a particular FPGA. In the following description a series of decryptions are described, at each stage the cryptographic checksum on the information being decrypted is checked and if an error is found the entire decryption process is aborted and the FPGA discontinues the download. The end user server encrypts the header and bitstream header information with its user key before downloading to the FPGA.

The FPGA decrypts the bitstream header information using the user key loaded from the header information in the nonvolatile memory. The bitstream header format was described above in conjunction with FIG. 12. If the checksum is correct and the user_id matches the FPGA knows that the download came from the end user and is intended for this FPGA chip. It then makes a note of the expected checksum on the bitstream information and continues to decrypt the next section of the file using the user_key. Preferably a small block of memory is provided on the FPGA chip as working storage for this decryption process.

Assuming that the block of information decrypted with the user key has a correct checksum the FPGA now has available the information encrypted with the user key in unencrypted form and can process it further. The first item of information is the customer_header, which was created by the FPGA while it was in the possession of the FPGA customer and is encrypted with the FPGA_key. The FPGA now decrypts this block to obtain the user_key for the FPGA customer. Using this key the FPGA can decrypt the Customer bitstream header. The FPGA then checks that the user_id in the customer bitstream header matches that in the Customer header (which proves that the customer intended the bitstream to be supplied to this FPGA) and that the expected checksum on the bitstream is the same as that obtained previously from the user bitstream header.

The FPGA then goes on to decrypt the set of information supplied by the TEP and encrypted with the customer key. It decrypts the TEP_header using the FPGA key to obtain the TEP user key and user_id. Based on these keys it decrypts the TEP bitstream header and checks that the user_id is matches that obtained from the TEP header to determine that the bitstream is intended for this FPGA. It also checks that the expected bitstream checksum matches that obtained from the customer bitstream header. If these tests are passed the FPGA goes on to decrypt the TEP bitstream to obtain the new configuration information.

Furthermore, since the key used to encrypt the bitstream is specified by the TEP it is easy for anyone authorized by the TEP to decrypt the bitstream to obtain a standard unencrypted bitstream as produced by the FPGA design tools. This allows the user to demonstrate to a regulator or other agency that a particular encrypted bitstream corresponds to a given set of high level design files as easily as they could with a nonencrypted design.

Nested Cores and VASSPs

This licensing scheme can be extended so that cores can contain cores and entire chip designs can be made available as pay-per-use downloads. The ability to sell cores which contain cores from other vendors is an important extension of the business model allowing designers with system level expertise to create large cores built on top of smaller functions from other designers. The end customer then pays all the necessary license fees.

The ability to sell full chip designs creates a market where “virtual application specific standard part (VASSPs)” can be sold to customers who are familiar with board level design using catalogue components but have no wish to design FPGA configurations themselves. A virtual ASSP is equivalent to a catalogue part which implements a particular desired function but is in fact implemented as an FPGA. VASSP customers have no contact with FPGA implementation CAD tools but need to run the configuration software to download design bitstream files to the FPGA during manufacture. Important benefits are the ability to address lower volume markets cost effectively and the ability to provide a customizable solution.

It is straightforward for the implementation tools to produce a hierarchical listing of all the modules in a design—in fact this is commonly done and provided to the user in log files. Given a file containing a list of modules in the design all that is necessary is to determine which ones correspond to licensed IP and to produce a list of the licensed IP modules used. This list of IP modules can then be stored with the bitstream file for use in determining any payments due to core vendors. It is worth noting that some cores may be instanced more than once in the same design (for example a design might require two bus interfaces). Preferably, the TEP should support charging additional fees when a core is used more than once in a design but it should allow the core vendor to determine what the customer is charged twice in this situation. Core vendors may want to give a discount on the second and subsequent uses of a core in a design.

In the normal case bitstream files will only be made available to the customer who created them—in general customers do not want competitors to be able to make use of their designs. In the case of VASSPs however, entire bitstreams are purchased by customers who may never create their own designs at all. This requires some extensions to the accounting software on the TEP's computer to reflect the separation between “designers” who create bitstreams on the TEP's server and “customers” who purchase them. All designers will be almost certainly be customers (since they will wish to test their designs on FPGAs) but not all FPGA customers will be designers.

Some bitstreams may be available by the TEP to every user, some may be restricted to a particular group of users specified by the designer and some may be restricted to their designer.

In a preferred embodiment when a customer downloads a VASSP bitstream which contains other licensable cores or makes use of a core which contains other cores in their own design they are only billed for the use of the VASSP or the top level core. The TEP then bills the provider of the top level core or VASSP bitstream for any cores it contains. It is up to the core or VASSP designer to make sure that the charge they make is enough to cover any fees on the cores they use. This process may happen recursively—i.e., at the next level down cores may also contain cores. The advantage of this procedure is that the names of the “lower level” cores used in a higher level core or VASSP bitstream are confidential information of the core or VASSP designer which should not be disclosed to the core or VASSP customer by the TEP.

In an another, less preferred, embodiment the customer is billed directly by the TEP for all IP cores incorporated in the bitstream.

Public Key (Asymmetrical) Cryptography

One drawback of the first embodiment of the invention is that secret information must be stored on each FPGA chip. If an attacker is able to analyze the chip artwork he may be able to determine the key information for a chip. Given this information he could decrypt the bitstream file and produce an unencrypted bitstream. If FPGAs are provided with a mode supporting “backwards compatibility” to earlier devices in which they will load unencrypted bitstreams then as soon as an attacker has an unencrypted bitstream he can use it in an unlimited number of FPGAs free of charge. However, if FPGAs only load encrypted bitstreams then an unencrypted bitstream is of no value—an attacker would have to disassemble and analyze every chip into which he wished to load the bitstream in order to determine its particular key. Suitable analysis techniques are time consuming and expensive and destroy the chip so this is not an option. Security is provided by the difficulty of analyzing or copying the FPGA chips.

One weakness of this scheme is that, in theory, an attacker who obtained a nonencrypted bitstream could reverse-engineer the bitstream to determine original design information. If this reverse engineering is done successfully the attacker could then start with these design files, remove any copyright information, and use the normal CAD flow to create a design which would appear to be his property and have no pay-per-use fees attached.

It would be desirable to provide a security scheme which was not dependent on secret information being stored in the FPGA so that attacks which attempted to determine secret key information by analyzing the FPGA die were not of concern. This can be done using public key cryptography. In this scheme each FPGA contains a public key for the TEP (which may, for example, be embedded in the FPGA artwork or using laser programmed fuses) and a unique serial number (which may, for example, be embedded using laser programmed fuses). The security scheme does not rely on these numbers being secret, only on the fact that it would cost much more to alter the code on an FPGA chip than to pay the license fee for any cores.

In this scheme the TEP keeps the secret key corresponding to the public key embedded in the FPGAs on a secure server connected to the internet. In order to create a bitstream for a particular FPGA the customer configuration computer reads out the FPGA's serial number via JTAG and sends it to the TEP along with an identifier for the bitstream file to be loaded. The computer at the TEP then adds the chip identifier to the bitstream and calculates a cryptographic hash of the bitstream plus the identifier. It then encrypts this hash value using its secret key to create a “signed” hash value for the bitstream and appends the signed hash to the bitstream before sending it back to the user computer.

The FPGA then loads the bitstream with the signed hash and checks that the chip_identifier specified in the bitstream is equal to the one programmed into itself during manufacture. If so then it calculates the cryptographic hash of the bitstream, including the chip identifier and decrypts the signed hash transmitted with the bitstream using the on-chip public key for the FPGA manufacturer. If the decrypted hash is equal to the calculated hash then the bitstream was generated by the FPGA manufacturer for this particular FPGA and it can be loaded.

From time to time the TEP will wish to change its public/private key. This is standard practice to limit the length of time a hacker who has managed to access the private key can make use of it. Changing the keys is achieved by sending a new key to the FPGA manufacturer for implanting into chips at the time of manufacturing. The TEP, computer must also track which key should be used with a given chip. This is easily achieved since the chips report their identifier to the TEP. If the identifiers are sequential it is simply a matter of noting which ranges of identifiers have a given public key implanted (e.g., chips 0 to 10,000 have key 1, chips 10,001 to 20,000 have key 2 and so on). If the identifiers are not sequential then a database of identifier against key can be kept.

Design Watermarking

In this embodiment it is assumed that in some cases it is necessary for customers to be given access to the design source files for intellectual property cores. This creates the possibility that the customer will remove any copyright tag information from the design source and run it through the implementation tools as if it were their own design in order to avoid paying per-use license fees.

Watermarking techniques have been suggested in the technical literature by which a design can have additional information implanted into it which is very hard to remove (see, for example “Fingerprinting Intellectual Property Using Constraint Addition,” paper 36.2 in Proceedings of the 37th Design Automation Conference, Los Angeles Calif., Jun. 5-9, 2000, published by the Association for Computing Machinery which is incorporated by reference and the bibliographic references in that paper).

We assume that the TEP needs to approve bitstreams before they are downloaded into FPGA chips. That is, in this embodiment, the chips do not have a “backwards compatibility” mode in which nonencrypted designs can be loaded. Further we assume the TEP requires that the entire bitstream (rather than just a hash or checksum derived from the bitstream) is sent for approval. In this case the TEP can archive all bitstreams before encryption. This substantially increases the risk for any pirates who choose to use FPGA cores without paying license fees since the FPGA manufacturer has a complete database of bitstreams, the customer who created them and the number of times they have been used.

In an embodiment where designs must be processed by the TEP server it is easy for the TEP to check for watermarks indicating licensed IP cores before processing it. If the TEP has to run place and route tools it can check for watermarks in the design netlist rather than the bitstream.

It is also possible to put the watermark detection code into trusted software for design implementation (to check for watermarks in the netlist) or device configuration (to check for watermarks in the bitstream, prior to loading into the chip).

It is possible for the chip itself to check for watermarks and refuse to load the design unless the licensing information in the bitstream indicates that fees have been paid. However, due to the complexity of watermarking algorithms this is currently not a preferred technique. Advances in process technology and the general inclusion of relatively powerful microcontroller cores on FPGAs may make this technique more attractive in the future.

Copyright Tag Components

In this scheme the core vendor includes in the schematics or HDL source for their design a special component whose function is to provide core copyright information to the FPGA vendor's CAD tools. For example the component could be instanced as:

copyright (“vendor_name,” “core_name,” “core_parameters”);

By creating an explicit component to transfer copyright information to the implementation software one avoids the need to deduce information which may be used for billing from design files. If information is deduced rather than stated explicitly there is always the chance for error—for example, a user might inadvertently choose the same name for a component in his design as a core vendor uses for a licensed core and software might erroneously deduce that the core was used in the user design. FPGA vendors have used “dummy” components in designs to transfer non-netlist configuration information to the bitstream generation tools in the past—for example FPGAs contain components such as power on reset circuits and have various voltage options on I/O signals.

Parts with On-chip Nonvolatile Memory

Cryptographic techniques for protecting bitstream information have, in the past, been directed at SRAM programmed FPGAs which require an external nonvolatile memory to store configuration information, which can then be monitored as it passes onto the chip making it relatively straightforward to copy. Antifuse parts have a reputation for offering a high degree of protection against design piracy since it is very difficult to determine if a particular antifuse is programmed and therefore to obtain design information by examining a configured part. Further, antifuses can only be programmed once so there is much less scope for software download and reconfiguration in the field (although theoretically it is possible—for example by leaving an area of the chip deliberately empty and unprogrammed in the initial configuration).

The fact that a part is antifuse programmed does not provide any additional protection to IP core vendors since the FPGA customer will have a complete bitstream for use in the antifuse chip programmer and can program as many FPGA chips as they like with the bitstream. Accordingly it is worth considering cryptographic techniques by which antifuse FPGAs can be made to load only bitstreams generated specifically for a given part. These concerns also apply to other nonvolatile programming technologies such as FLASH and EPROM and upcoming technologies like magnetic and ferric ARM. Although the embodiment discussed below assumes antifuse technology the teachings could be applied by one skilled in the art to FPGAs based on other nonvolatile memory technologies.

In an antifuse programmed FPGA it makes sense to use antifuses to store secret key and chip identifier information. These antifuses can easily be programmed before the chip leaves the FPGA manufacturer. The technique of the first embodiment can be used in which the FPGA manufacturer maintains a database of secret key and chip identifier.

A difference between antifuse FPGAs and SRAM programmed FPGAs is that no external nonvolatile memory is required. As soon as the bitstream data is decrypted and loaded into the chip itself the antifuses are programmed and cannot be reprogrammed. Most cryptographic techniques only provide a checksum to verify the configuration information after the entire bitstream has been loaded. In the case of an antifuse FPGA this is too late—if there has been a problem the chip is already programmed with bad data and is effectively scrap. Therefore, it may be worth extending the protocol so that the chip can check that the bitstream has been encrypted with the correct key using some additional header information before it starts to decode the actual bitstream and program antifuses.

In the future it may be possible to cost-effectively integrate blocks of FLASH memory onto FPGA chips without compromising speed. Flash memory based FPGAs are already available from Actel corporation. Research is also underway into nonvolatile RAM technologies based on magnetic effects. On chip nonvolatile memory may be a separate block whose data is transferred into SRAM configuration memory on power up or the nonvolatile memory cells may directly control the programmable switches. Use of nonvolatile memory on chip removes some security problems—in particular the need to communicate configuration information between an external nonvolatile memory and the FPGA on power up. However, it does not remove the need for cryptography to support per-use licensing of IP and software download. It may be possible to physically analyze chips to determine the values stored in nonvolatile memory cells so there is also some reason for encrypting data stored in on chip nonvolatile memories when these do not directly control configuration switches. Many of the cryptographic techniques disclosed in this application can be equally well applied to chips with nonvolatile configuration memory.

SIM Card Replacement

Today, in most mobile telephones a separate subscriber identification module (SIM) card is provided to identify the subscriber to the network. The SIM card contains a secure microcontroller with a small amount of nonvolatile memory which can be used to store service information and address book information. The cellphone itself has a much more powerful processor and a much larger nonvolatile FLASH memory which holds program code. However, network operators are unwilling to store sensitive information in this large memory because of security concerns. A hacker could simply readout the large memory to obtain sensitive information—for example in order to access telephone services without paying.

The secure microcontroller in the SIM card addresses these security concerns but at the expense of adding considerable expense to the handset and an additional component which must be managed in the sales channel. Ideally, instead of having a physical SIM card, service information to enable the telephone could simply be downloaded over the radio from the network.

This disclosure has covered cryptographic techniques by which a large external volatile memory, such as the program memory in cellular telephones, can be secured. Secure microcontroller or DSP code can be loaded from the external nonvolatile memory, decrypted and stored in an on-chip block of volatile random access memory (RAM) for execution in the same way as FPGA configuration information is loaded, decrypted and stored in on-chip configuration memory. Further, layered encryption allows all parties involved: cellphone chipset manufacturer, cellphone manufacturer, network operator, service provider and user to take control of the software download process. Thus it is possible to securely download new software and service information into the cellphone. Software download can be used not only for the relatively small amount of information stored in the SIM card (such as user phone number lists and service information) but also the remainder of the cellphone's software. In a “software radio” strategy basic radio functions such as modulation, demodulation and channel selection are implemented in software. FPGA cores may be used to implement signal processing functions which require both high performance and configurability.

Partial Reconfiguration

The preceding discussion has assumed that the FPGA chips are configured entirely by a single bitstream file. This is generally the case in current practice but considerable research interest has focussed on partial and dynamic reconfiguration. In partial reconfiguration a bitstream file may configure only a section of the chip. In some devices such as the Xilinx XC6200 family this can be done while user circuitry configured onto other areas of the chip remains operational. In dynamic reconfiguration areas of the chip are reconfigured in the course of a computation so that a larger design than will fit on the chip at one time can be implemented.

The security technique of the present invention can be extended to include these scenarios by independently protecting the “bitstream segments” in the same way as the entire bitstream was previously protected.

In U.S. Pat. No. 5,946,478 assigned to Xilinx Inc. which is incorporated by reference a method for creating “secure macro elements” for FPGA designs is proposed. These macro elements are compiled to partial bitstream files which are then supplied to the designer and linked together into the design file. Supplying partial bitstream files rather than netlist files is an alternative approach to encrypting design netlist files to protect intellectual property as described in earlier embodiments. An extension of the technique based on a partial reconfiguration capability would be for the final design bitstream to be composed of several partial bitstream files. The portion of the design created by the FPGA designer could be in a separate partial bitstream file from design portions created by various core vendors. Each bitstream portion could be protected separately using the cryptographic techniques of this invention so that the user_key for each bitstream portion was different and only known to the creator of that portion. This technique could remove the need for a TEP since there is now no need for a single party to be trusted with the complete set of design information.

Use with Microcontroller

Many of the more recent FPGA devices include an on-chip microcontroller. Bitstream formats have been developed for these devices which include both FPGA configuration information and microcontroller code. Most of these devices include on-chip memory blocks into which microcontroller code is loaded and from which it is executed. Bitstream information containing microcontroller code to be loaded into on-chip memory can be treated exactly the same way as FPGA configuration information for the purposes of this invention. It is more difficult to cryptographically protect microcontroller code which is run from external memory so it is generally recommended that only parts of the code which do not require protection are run from external memory.

Additional Precautions in Secure FPGA

Some additional security precautions not found on conventional FPGAs are required on the secure FPGA chip:

Secure bitstreams must be able to shut off access mechanisms commonly provided for design debugging which allow users direct access to read back configuration information or access register information within user designs.

It must be impossible for user microcontroller code or user FPGA bitstreams to access the on-chip secret key. If such access was possible a design could be created which transferred key information off chip.

Since it is problematic for user code or user designs to access the secret key it is considered preferable to provide a separate hard-wired encryption unit for the lowest level encryption rather than use microcontroller code or designs loaded onto the FPGA to perform this function.

Although it is preferred that the lowest level of cryptographic protection which secures the external nonvolatile memory is provided by fixed hardware on the device additional layers of protection might be best implemented in microcontroller code or user FPGA configurations. Once the initial layer of hardware protection is in place it can secure the microcontroller code or user FPGA configurations used in additional layers, e.g., to secure a network connection for download. Allowing the use of user logic or microcontroller code for higher level encryption functions means that the FPGA is not limited to any particular encryption algorithm selected by its manufacturer. User_key and user_identifier information can be built into the bitstream for the encryption functions so they are not limited to any particular size of register provided on the chip. However, using user resources for design protection s likely to be inconvenient and expensive in resources compared with using the built in hardware.

Implementing Chip Keys Using Laser Programmed Fuses

An attractive technique for implementing per-chip customization is to provide metal segments which can be cut by a laser beam during manufacture. This technique has been used in fault-tolerance schemes for dynamic random access memories for some time and is low cost and suitable for high volume production.

A problem with laser fuses in the context of a security scheme is that since they must be relatively large and on top level metal to be easily programmed by a laser it is relatively straightforward for a well equipped attacker to remove the chip from its packaging and use a microscope to determine the settings of any laser programmed fuses.

If the laser fuses are used to implement security features such as public keys or chip identification numbers which must be chip specific and hard to alter without damaging the chip but are not secret then this is not a problem. However it is a major concern if the laser programmed fuses are to implement secret keys.

Several techniques are available to combat the visibility of the fuses. The basic idea is to combine the customizability of the fuses with the difficulty of analysis but lack of customizability of mask programmed connections. The applicant's previous patent application GB 0002829.0 described various techniques for implementing a key using mask programming and is incorporated by reference.

In an embodiment more laser fuses than are actually required for the number of bits in the key can be provided. These additional bits can also be laser programmed, since if some bits are never cut by the laser an attacker could determine which bits were dummies by analyzing a large number of chips.

In an embodiment the ordering of the fuses compared with the bits of the key is scrambled using wiring on other mask layers. In an embodiment active circuitry is used to scramble the bits of the key.

In a preferred embodiment the key is calculated from a number of laser fuses larger than the number of bits in the key. This can be done, for example, using a cryptographic hash algorithm or message authentication code and a secret key embedded in the chip masks. In this embodiment there is no simple relationship between the values in the laser programmed fuses and the bits of the key.

In an embodiment some bits of the key are determined by laser fuses whereas others are determined solely from the mask work.

In an embodiment the fuses encode the chip identifier and the chip secret key is determined by an encryption or secure hash algorithm operating on the serial number based on a secret key embedded in the device maskwork.

### SUMMARY

This application describes many embodiments and modes of use of a novel configuration method for FPGAs in which a cryptography is used in conjunction with key information stored on each FPGA chip to ensure that bitstreams have to be created individually for each chip. The requirement to create individual bitstreams for each chip and to obtain cooperation from a third party in doing so allows new business models in which users must pay for each time an intellectual property core is configured into an FPGA chip and for each time an FPGA chip is configured. These business models allow FPGAs to compete more effectively with ASICs and create a viable business in providing intellectual property for FPGAs.

While the technique has been described with reference to FPGAs once skilled in the art will recognize that it is equally applicable to other programmable classes of integrated circuit. Such chips would include field programmable interconnect components (FPICs), microcontrollers with on-chip SRAM program and data memory and hybrid chips containing, for example, a microcontroller and an area of programmable logic. They also include more recent devices which are configured like FPGAs but operate on words of data more than one-bit wide to implement computational functions and devices with more than one plane of configuration memory.

Many variations of the intellectual property protection technique have been described. The marketplace for FPGAs and programmable chips is complex and potential users of the technology have a variety of existing products and business models. Commercial implementations of the security technology may well incorporate several of the alternative embodiments described in order to appeal to a wider range of potential customers and provide backward compatibility to existing tools and products.

While the description above contains many specific details, these should not be construed as limitations on the invention, but rather as an exemplification of one preferred embodiment thereof. Many other variations are possible.

Accordingly, the scope of the invention should be determined not by the embodiments illustrated but by the appended claims and their legal equivalents.

What is claimed is:

1. A method comprising:
manufacturing field programmable gate array integrated circuits, each integrated circuit having an identification code and a secret cryptographic key; and
creating a database of identification codes and secret cryptographic keys, wherein a field programmable gate array integrated circuit with a particular identification code is configurable using a bitstream encrypted using a secret cryptographic key associated with the particular identification code;
wherein the encrypted bitstream configures the field programmable gate array integrated circuit with the particular identification code by programming a plurality of electrical switches in the field programmable gate array integrated circuit to create a circuit corresponding to a user design.
